(19) United States
(12) Patent Application Publication
(10) Pub. No.: US 2026/0017978 A1
(43) Pub. Date: Jan. 15, 2026

(54) IDENTITY RECOGNITION METHOD AND APPARATUS, COMPUTER DEVICE, AND STORAGE MEDIUM

(71) Applicant: Tencent Technology (Shenzhen) Company Limited, Shenzhen (CN)

(72) Inventors: Lei SHEN, Shenzhen (CN); Ruixin ZHANG, Shenzhen (CN); Shouhong DING, Shenzhen (CN)

(73) Assignee: Tencent Technology (Shenzhen) Company Limited, Shenzhen, GD (CN)

(21) Appl. No.: 19/330,364

(22) Filed: Sep. 16, 2025

Related U.S. Application Data
(63) Continuation of application No. PCT/CN2024/102418, filed on Jun. 28, 2024.

(30) Foreign Application Priority Data
Sep. 7, 2023 (CN) 202311149821.7

(51) Int. Cl. G06V 40/12; G06V 10/25; G06V 10/74; G06V 10/77; G06V 10/774; G06V 10/82

(52) U.S. Cl. CPC G06V 40/1365; G06V 10/25; G06V 10/761; G06V 10/7715; G06V 10/774; G06V 10/82; G06V 40/1347

(57) ABSTRACT

An identity recognition method, includes: obtaining a biological part image acquired for a target part of a to-be-recognized user; determining a feature form type of the target part, and extracting respective form features of pixels from the biological part image based on an image feature form matching the feature form type, where the image feature form is a form obtained after respective distribution positions of feature extraction coverage pixels are combined, and the feature extraction coverage pixels are pixels that are in the biological part image and targeted by each feature extraction; obtaining a biological part feature of the to-be-recognized user based on the respective form features of the pixels; and performing feature matching on the biological part feature and registered part features of registered users, to obtain feature matching results, and determining an identity recognition result of the to-be-recognized user based on the feature matching results.

### RELATED APPLICATION

This application is a continuation application of PCT Patent Application No. PCT/CN2024/102418, filed on Jun. 28, 2024, which claims priority to Chinese Patent Application No. 202311149821.7, filed with the China National Intellectual Property Administration on Sep. 7, 2023, each of which is incorporated herein by reference in its entirety.

### FIELD OF THE TECHNOLOGY

This disclosure relates to the field of computer technologies, and in particular, to an identity recognition method and apparatus, a computer device, a storage medium, and a computer program product.

### BACKGROUND OF THE DISCLOSURE

With the development of computer technologies, increasingly mature identity recognition technologies are widely applied in various fields such as business cooperation, consumption payment, social media, and security protection. Identity recognition is performed by using an inherent biological feature of a person, for example, a biological feature of a local part like a hand shape, a fingerprint, a face shape, a retina, or an auricle, which has become a development trend of the identity recognition technologies.

Currently, in the identity recognition technologies based on a biological feature of a local part, when a user performs identity recognition by using the biological feature such as a hand shape, a human face, a fingerprint, or a palm print, an image of a local part is usually collected, and a biological feature is extracted from the collected image of the part to perform identity recognition. However, currently, accuracy of the extracted biological feature is relatively low, resulting in relatively low accuracy of identity recognition.

### SUMMARY

According to embodiments provided in this disclosure, an identity recognition method and apparatus, a computer device, a computer-readable storage medium, and a computer program product are provided.

According to an aspect, this disclosure provides an identity recognition method, performed by a computer device. The method includes:
obtaining a biological part image acquired for a target part of a to-be-recognized user;
determining a feature form type of the target part, and extracting respective form features of pixels from the biological part image based on at least one image feature form matching the feature form type, where the image feature form is a form obtained after respective distribution positions of feature extraction coverage pixels are combined, and the feature extraction coverage pixels are pixels that are in the biological part image and targeted by each feature extraction;
obtaining a biological part feature of the to-be-recognized user based on the respective form features of the pixels; and
performing feature matching on the biological part feature and registered part features, to obtain feature matching results, and determining an identity recognition result of the to-be-recognized user based on the feature matching results, where the registered part feature is a biological part feature obtained by performing identity registration on a biological part image corresponding to the target part of a registered user.

According to another aspect, this disclosure further provides an identity recognition, applied to a computer device. The apparatus includes:
a part image obtaining module, configured to obtain a biological part image acquired for a target part of a to-be-recognized user;
a form feature extraction module, configured to: determine a feature form type of the target part, and extract respective form features of pixels from the biological part image based on at least one image feature form matching the feature form type, where the image feature form is a form obtained after respective distribution positions of feature extraction coverage pixels are combined, and the feature extraction coverage pixels are pixels that are in the biological part image and targeted by each feature extraction;
a biological part feature obtaining module, configured to obtain a biological part feature of the to-be-recognized user based on the respective form features of the pixels; and
a feature matching module, configured to: perform feature matching on the biological part feature and registered part features, to obtain feature matching results, and determine an identity recognition result of the to-be-recognized user based on the feature matching results, where the registered part feature is a biological part feature obtained by performing identity registration on a biological part image corresponding to the target part of a registered user.

According to another aspect, this disclosure further provides a computer device, including a memory and a processor, where the memory has computer-readable instructions stored therein, and the processor, when executing the computer-readable instructions, implements the operations of the foregoing identity recognition method.

According to another aspect, this disclosure further provides a computer-readable storage medium, having computer-readable instructions stored therein, where when the computer-readable instructions are executed by a processor, the operations of the foregoing identity recognition method are implemented.

According to another aspect, this disclosure further provides a computer program product, including computer-readable instructions, where when the computer-readable instructions are executed by a processor, the operations of the foregoing identity recognition method are implemented.

Details of one or more embodiments of this disclosure are provided in the accompanying drawings and descriptions below. Other features and advantages of this disclosure become apparent with reference to the specification, the accompanying drawings, and the claims.

### BRIEF DESCRIPTION OF THE DRAWINGS

To describe the technical solutions in embodiments of this disclosure or the conventional technology more clearly, the following briefly describes the accompanying drawings required for describing the embodiments or the conventional technology. Apparently, the accompanying drawings in the following descriptions show merely the embodiments of this disclosure, and a person of ordinary skill in the art may still obtain other accompanying drawings according to the disclosed accompanying drawings without creative efforts.

FIG. 1 is a diagram of an application environment of an identity recognition method according to an embodiment.

FIG. 2 is a schematic flowchart of an identity recognition method according to an embodiment.

FIG. 3 is a schematic diagram of application of palm print recognition according to an embodiment.

FIG. 4 is a schematic diagram of an annular feature extraction unit according to an embodiment.

FIG. 5 is a schematic diagram of a line feature extraction unit according to an embodiment.

FIG. 6 is a schematic diagram of an annular convolution kernel according to an embodiment.

FIG. 7 is a schematic diagram of a linear convolution kernel according to an embodiment.

FIG. 8 is a schematic flowchart of an identity recognition method according to another embodiment.

FIG. 9 is a schematic flowchart of determining a region of interest according to an embodiment.

FIG. 10 is a schematic flowchart of a palm print recognition method according to an embodiment.

FIG. 11 is a schematic diagram of determining a region of interest according to an embodiment.

FIG. 12 is a schematic diagram of a 9*9 linear convolution kernel according to an embodiment.

FIG. 13 is a schematic diagram of a 16*16 linear convolution kernel according to an embodiment.

FIG. 14 is a structural block diagram of an identity recognition apparatus according to an embodiment.

FIG. 15 is a diagram of an internal structure of a computer device according to an embodiment.

### DESCRIPTION OF EMBODIMENTS

The technical solutions in embodiments of this disclosure are clearly and completely described below with reference to the accompanying drawings in the embodiments of this disclosure. Apparently, the described embodiments are merely a part rather than all of the embodiments of this disclosure. All other embodiments obtained by a person of ordinary skill in the art based on the embodiments of this disclosure without any creative effort shall fall within the protection scope of this disclosure.

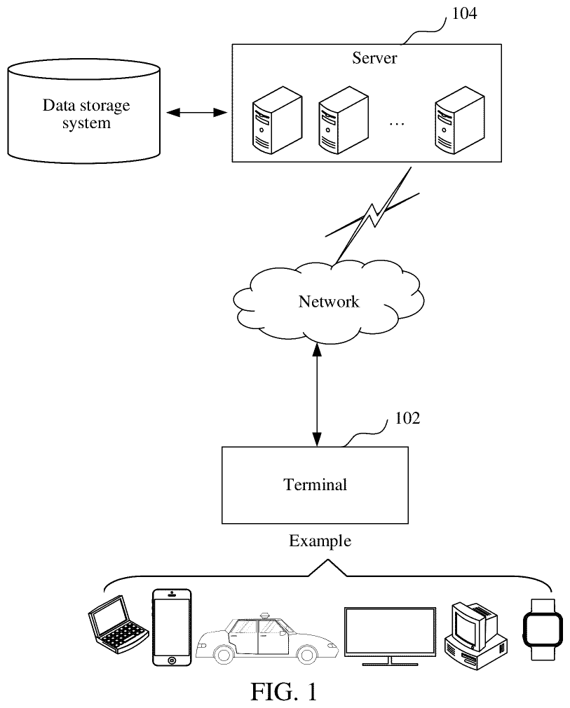

An identity recognition method provided in the embodiments of this disclosure may be applied to an application environment shown in FIG. 1. A terminal 102 communicates with a server 104 through a network. A data storage system may store data that needs to be processed by the server 104. The data storage system may be arranged separately, or may be integrated on the server 104, or may be arranged on a cloud or another server. The terminal 102 may collect an image of a target part of a to-be-recognized user, to obtain a biological part image of the target part. Specifically, the terminal 102 may collect the biological part image of the target part of the to-be-recognized user in response to an identity recognition trigger event. For example, the terminal 102 may collect a biological part image such as a palm part image or a finger part image of the to-be-recognized user. The terminal 102 sends the collected biological part image to the server 104, so that the server 104 extracts respective form features of pixels from the biological part image based on at least one image feature form matching a feature form type of the target part. The image feature form is obtained after respective distribution positions of the pixels targeted by each feature extraction from the pixels are combined. The server 104 obtains a biological part feature of the to-be-recognized user based on the respective form features of the pixels; and performs feature matching on the biological part feature and registered part features of registered users, and determines an identity recognition result of the to-be-recognized user based on feature matching results. The server 104 may return the identity recognition result of the to-be-recognized user to the terminal 102, so that the terminal 102 performs processing based on the identity recognition result. For example, an access control of the to-be-recognized user may be released.

In addition, the server 104 may alternatively directly return the feature matching results to the terminal 102, so that the terminal 102 determines an identity recognition result of a target user based on the feature matching results returned by the server 104, thereby implementing identity recognition of the target user. In another optional application, processing of identity recognition may alternatively be implemented by the terminal 102 separately. That is, the terminal 102 extracts the respective form features of pixels from the biological part image based on at least one image feature form matching a feature form type of the target part. The terminal 102 obtains a biological part feature of the to-be-recognized user based on the respective form features of the pixels; and performs feature matching on the biological part feature and registered part features of registered users, and determines an identity recognition result of the to-be-recognized user based on feature matching results.

The terminal 102 may be but is not limited to various personal computers, laptops, smartphones, tablets, Internet of Things devices, and portable wearable devices. The Internet of Things devices may include smart speakers, smart televisions, smart air conditioners, smart in-vehicle devices, or the like. The portable wearable devices may be smart watches, smart bands, head-mounted devices, or the like. The terminal 102 may be configured with a sensor device for collecting a part image of a target part of a user, to collect a biological feature of the target part. The server 104 may be implemented by using an independent server or a server cluster which includes a plurality of servers, or may be implemented based on a cloud server.

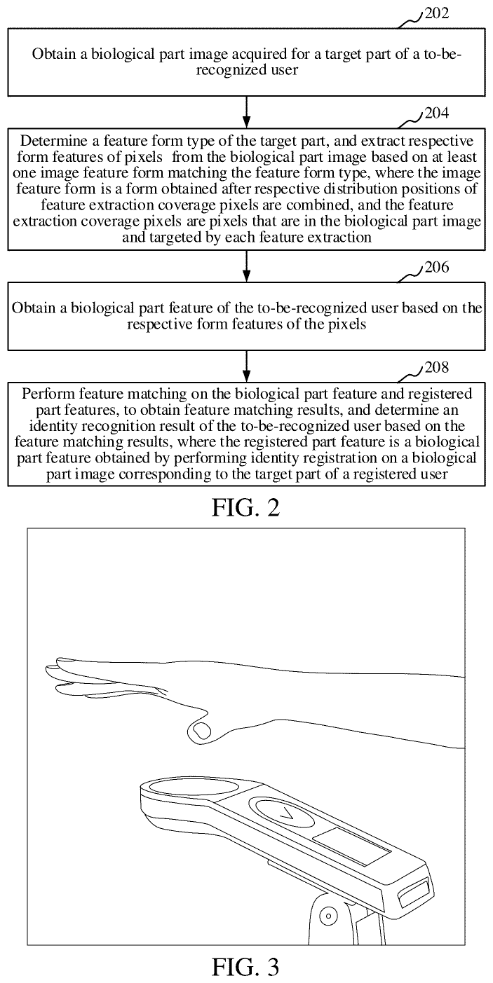

In an embodiment, as shown in FIG. 2, an identity recognition method is provided, which is performed by a computer device. Specifically, the method may be separately performed by a computer device such as a terminal or a server, or may be jointly performed by the terminal and the server. In this embodiment of this disclosure, description is provided by using an example in which the method is applied to the server in FIG. 1, and the method includes the following operation 202 to operation 208.

Operation 202: Obtain a biological part image acquired for a target part of a to-be-recognized user.

Identity recognition is an authentication process of recognizing whether a real identity of a user is consistent with an identity that the user claims to be. With the development of identity recognition technologies, a biological feature-based identity recognition manner is widely used. Identity recognition processing can be applied to various scenarios, and may be triggered based on an identity recognition trigger event. The identity recognition trigger event refers to an event that triggers identity recognition, and may specifically include, but is not limited to, an operation or an instruction that triggers the identity recognition. For example, in an access control system scenario, when a user needs to pass access control, the identity recognition event may be triggered to perform identity recognition processing on the user. For another example, when the user pays on a payment terminal, the identity recognition event may be triggered. As shown in FIG. 3, the target part may be a palm. A terminal may collect an image of the palm of a to-be-recognized user, to obtain a biological part image. The biological part image is specifically a palm image, and identity recognition processing may be performed based on the palm image. In addition, identity recognition may further be applied to an anti-addiction system scenario. For example, in an anti-addiction system of an online game, online game time of a juvenile needs to be limited. In this case, when anti-addiction is triggered, for example, when cumulative duration of the online game of a game user reaches a preset duration threshold, an identity recognition event may be triggered, to perform identity recognition on the game user. Through the identity recognition, it is determined whether the game user is an adult or whether the game user is a game account owner, to limit the online game time of the juvenile.

The identity recognition processing is implemented based on a collected biological feature. The biological feature is a part feature of a body part of a user that may be measured, for example, various types of biological features such as a hand shape, a fingerprint, a face shape, an iris, a retina, and a palm. When the identity recognition processing is performed by using the biological feature of the measurable body part of the user, biological data needs to be collected from the body part of the user, and the biological feature is extracted from the collected biological data, to perform identity recognition for the user based on the extracted biological feature. For example, when identity recognition is performed based on fingerprint recognition, fingerprint data needs to be collected from a thumb of the user, and the identity recognition is performed on the user based on the collected fingerprint data such as a fingerprint image. For another example, if identity recognition is performed based on a palm part, palm data needs to be collected from a palm of the user, and the identity recognition is performed on the user based on the collected palm data.

The to-be-recognized user is a user on which identity recognition needs to be performed, such as a user that triggers the identity recognition event. For example, when the user passes through an access control system, the user may enter a data collection region of the access control system. In the data collection region, when the access control system detects that the user exists, it indicates that identity recognition needs to be performed, and the identity recognition is triggered. The access control system collects biological data of the to-be-recognized user in the data collection region, for example, collects various biological data such as human face data, finger data, or palm data of the to-be-recognized user. The target part is a corresponding human body part from which the biological data needs to be collected, and the target part is related to the biological data or a biological feature related to the identity recognition. For example, the identity recognition is human face-based identity recognition. In this case, the corresponding target part is a human face part of the to-be-recognized user on which the identity recognition needs to be performed, the collected biological data is human face data, which may be specifically a human face image, and the biological feature of the identity recognition is a human face feature. For another example, the identity recognition is palm-based identity recognition. In this case, the corresponding target part is a palm part of the to-be-recognized user, the collected biological data is palm data, which may be specifically a palm image, and the biological feature of the identity recognition is a palm feature. The biological part image is an image collected from the target part, and the biological part image carries a biological feature corresponding to the target part. For example, when the target part is a human face part, the biological part image may be a human face image. When the target part is a finger, the biological part image may be a finger image. When the target part is a palm, the biological part image may be a palm image.

Specifically, the server may obtain the biological part image, where the biological part image is collected from the target part of the to-be-recognized user. For example, the biological part image may be collected from the target part of the to-be-recognized user by using a camera. Biological part images carrying different biological features may be collected from different target parts. Specifically, the terminal may perform image collection on the target part of the to-be-recognized user to obtain the biological part image, and send the collected biological part image to the server.

Operation 204: Determine a feature form type of the target part, and extract respective form features of pixels from the biological part image based on at least one image feature form matching the feature form type, where the image feature form is a form obtained after respective distribution positions of feature extraction coverage pixels are combined, and the feature extraction coverage pixels are pixels that are in the biological part image and targeted by each feature extraction.

The feature form type refers to an expression form corresponding to the biological feature carried in the target part. For different target parts, expression forms reflected by biological feature information are different. For example, for a finger, the biological feature information is mainly reflected through a texture of the finger. Therefore, the feature form type may be a texture type formed by textured skin on a finger pulp at an end of the finger, and may specifically include form types such as a whorl type, an arch type, and a loop type. For another example, for a palm, the biological feature information may be reflected through a palm print line or a palm vein line of the palm. Therefore, the corresponding feature form type may be a print line type of a palm print or a palm vein of the palm, and may be specifically a line form type.

The image feature form refers to a feature form adopted when feature extraction is performed on the biological part image of the target part. The image feature form matches the feature form type of the target part, and may specifically correspond to a corresponding expression form of the biological feature carried by the target part, to be suitable for extracting the biological feature carried by the target part. Different types of image feature forms may correspond to different feature extraction manners, so that feature extraction may be performed by using a feature extraction manner matching the feature form type of the target part, thereby improving a feature extraction effect. In some embodiments, an adaptive correspondence between the image feature form and the feature form type may be configured based on a plurality of test results. In specific implementation, a plurality of candidate image feature forms may be predetermined. For the feature form type of each biological part, feature extraction may be performed respectively by using various candidate image feature forms. According to a corresponding feature extraction result of each candidate image feature form, the server may determine an image feature form suitable for the feature form type from the various candidate image feature forms, to establish the adaptive correspondence between the image feature form and the feature form type.

The image feature form is a form obtained after the respective distribution positions of the pixels targeted by each feature extraction are combined. Specifically, during each feature extraction performed on pixels in the biological part image, after the respective distribution positions of the targeted pixels, that is, feature extraction coverage pixels in the biological part image, are combined, an obtained form conforms to the image feature form. The image feature form may be implemented based on a feature extraction unit. For example, when the target part is a finger, the feature form type may include a helical form, and the image feature form may also be a helical form. Specifically, feature extraction may be performed by using a helical feature extraction unit. That is, during each feature extraction, the form of a combination of respective distribution positions of the targeted feature extraction coverage pixels in the biological part image is a helical form. In a specific application, during each feature extraction, the formed form of the combination of respective distribution positions of the targeted pixels may be determined, and the formed form is judged. For example, the formed form may be matched with various candidate image feature forms, to determine whether the formed form matches the image feature forms, and to determine whether the form of the combination of the respective distribution positions of the pixels targeted by each feature extraction is the image feature form matching the feature form type. The image feature form may include at least one form, so that feature extraction may be performed on the biological part image based on one or more image feature forms, to obtain the respective form features of the pixels in different image feature forms.

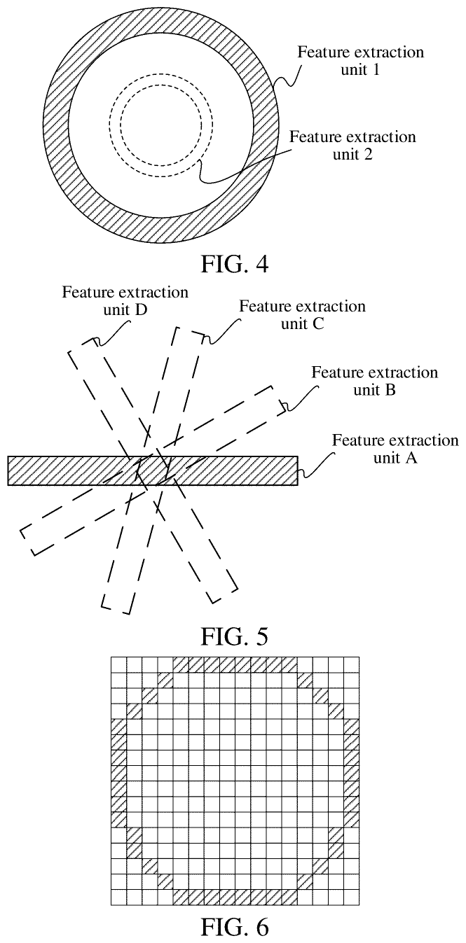

In a specific application, the image feature form may be implemented by using a corresponding feature extraction unit. That is, feature extraction is performed by using a feature extraction unit whose shape matches the image feature form, to obtain the respective form features of the pixels. As shown in FIG. 4, when the image feature form is an annular form, feature extraction may be performed on the biological part image based on an annular feature extraction unit 1 and an annular feature extraction unit 2. The feature extraction unit 1 and the feature extraction unit 2 may have different sizes, that is, when feature extraction is performed on the biological part image, feature extraction is performed only on pixels in an annular region covered by the annular feature extraction unit. As shown in FIG. 5, when the image feature form is a line form, feature extraction may be performed on the biological part image based on a line feature extraction unit. For example, feature extraction may be performed on the biological part image by using a feature extraction unit A in a horizontal direction. The feature extraction unit A in the horizontal direction is rotated, and according to rotation angles, a feature extraction unit B, a feature extraction unit C, and a feature extraction unit D in different directions may be obtained, so that feature extraction units in a plurality of directions may be formed to perform feature extraction.

The form feature is a feature extraction result obtained by performing feature extraction on the biological part image based on the image feature form. The form feature corresponds to a pixel, that is, the respective form features may be separately extracted for the pixels in the biological part image. For the pixels in the biological part image, a corresponding form feature may be extracted for each pixel in each image feature form. If feature extraction is performed on the biological part image by using three image feature forms, form features that are respectively in a one-to-one correspondence with the three image feature forms may be respectively extracted for each pixel, that is, three form features may be obtained for each pixel.

Specifically, for the biological part image, the server may determine at least one image feature form, and perform feature extraction on the biological part image based on the at least one image feature form, to obtain the respective form features of the pixels in the biological part image. When feature extraction is performed on the biological part image based on the image feature form, after the respective distribution positions of the targeted pixels during each feature extraction, that is, the feature extraction coverage pixels, are combined, a corresponding image feature form may be formed. The at least one image feature form matches the feature form type of the target part. The server may determine the feature form type of the target part, and determine the at least one matching image feature form according to the feature form type. In specific implementation, after the server determines the feature form type of the target part, if a plurality of feature form types are included, the server may select at least one feature form type from the plurality of feature form types. For example, at least one feature form type having a highest frequency may be selected, and at least one corresponding matching image feature form is determined. The server may alternatively directly determine respective matching image feature forms based on the plurality of feature form types.

In an exemplary application, the image feature form may be implemented based on a feature extraction unit. Specifically, the feature extraction unit may be implemented based on a convolution kernel, that is, feature extraction is performed on the biological part image by using at least one convolution kernel matching the feature form type of the target part, to obtain the respective form features of the pixels in the biological part image. For example, when the target part is a palm, the feature form type may be a linear type, so that at least one linear convolution kernel may be determined. Each linear convolution kernel may have a different direction, so that feature extraction may be performed on a palm image based on a linear convolution kernel in at least one direction, thereby effectively extracting a palm print line feature in the palm image.

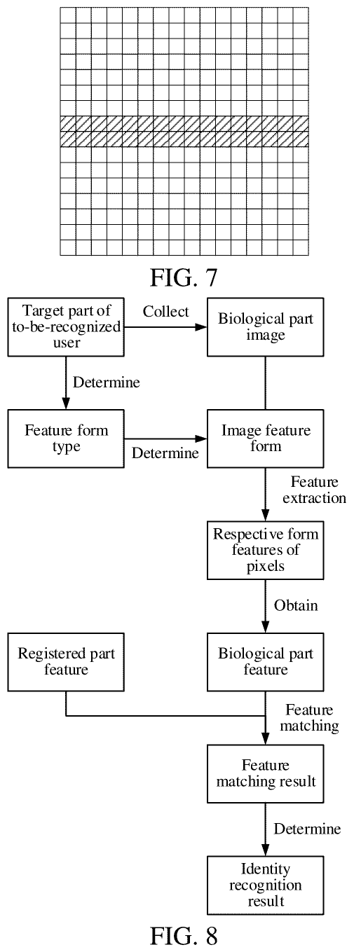

As shown in FIG. 6, in a convolution kernel at a scale of 16*16, by setting a unit of a convolution kernel filled with an oblique line to be valid, for example, a convolution kernel weight may be set to 1, and by setting a unit of a convolution kernel not filled with an oblique line to be invalid, for example, a convolution kernel weight may be set to 0, an annular convolution kernel may be formed, so that feature extraction may be performed based on an annular image feature form. As shown in FIG. 7, in a convolution kernel at a scale of 16*16, by setting a unit of a convolution kernel filled with an oblique line to be valid and by setting a unit of a convolution kernel not filled with an oblique line to be invalid, a linear convolution kernel in a horizontal direction may be formed. Feature extraction is performed on the biological part image based on the linear convolution kernel in the horizontal direction, to obtain a line form feature in the horizontal direction.

Operation 206: Obtain a biological part feature of the to-be-recognized user based on the respective form features of the pixels.

The biological part feature is configured for representing the biological feature carried in the target part of the to-be-recognized user. Target parts of different users may correspond to different biological part features, so that identity recognition processing may be performed on the users based on the biological part features.

Specifically, for the respective form features of the pixels in the biological part image, the server may determine the biological part feature of the to-be-recognized user based on the respective form features of the pixels. For example, when a quantity of the form features of each pixel is 1, the server may directly splice the respective form features of the pixels, to obtain a form feature of the biological part image and obtain the biological part feature of the to-be-recognized user based on the form feature of the biological part image. For example, the server may directly use the form feature of the biological part image as the biological part feature of the to-be-recognized user, and may further perform feature extraction on the form feature of the biological part image. Specifically, feature extraction may further be performed on the form feature of the biological part image by using a pre-trained feature extraction model, to obtain the biological part feature of the to-be-recognized user. In addition, when each pixel includes at least two form features, it indicates that there are at least two image feature forms. For each pixel, the server may fuse a plurality of form features of the pixel, and then splice the fused form features, to obtain the form feature of the biological part image and obtain the biological part feature of the to-be-recognized user based on the form feature of the biological part image.

Operation 208: Perform feature matching on the biological part feature and registered part features, to obtain feature matching results, and determine an identity recognition result of the to-be-recognized user based on the feature matching results, where the registered part feature is a biological part feature obtained by performing identity registration on a biological part image corresponding to the target part of a registered user.

The registered part feature is the biological part feature obtained by performing identity registration on the biological part image corresponding to the target part of the registered user. The registered part feature of the registered user may be used as a reference feature for identity recognition, and the biological part feature of the to-be-recognized user is matched with the registered part features. Therefore, the identity recognition result of the to-be-recognized user may be determined based on the feature matching results. For example, it is determined whether the to-be-recognized user belongs to a registered user, and if the to-be-recognized user belongs to a registered user, a specific user identifier of the to-be-recognized user may be further determined.

Specifically, the server may perform identity recognition based on the biological part feature of the to-be-recognized user. Specifically, the server may obtain the registered part feature obtained by performing identity recognition in advance by the registered user. The server performs feature matching on the biological part feature and the registered part features respectively, to obtain feature matching results. The server determines the identity recognition result of the to-be-recognized user based on the feature matching results. Specifically, the server may determine whether the to-be-recognized user belongs to a registered user based on the feature matching results, and if the to-be-recognized user belongs to a registered user, may further determine user identity information of the to-be-recognized user. In a specific application, the user may register an identity in advance by using the biological part image corresponding to the target part. Specifically, the biological part feature may be extracted based on the biological part image corresponding to the target part, and the extracted biological part feature is bound to the user identifier, to implement identity registration of the user. The registered part feature is obtained based on the biological part feature when the registered user registers the identity, to use the registered part feature of each registered user as a reference feature for performing identity recognition.

In a specific application, as shown in FIG. 8, a biological part image may be collected for a target part of a to-be-recognized user, and the server may obtain the collected biological part image. The server may determine a feature form type corresponding to the target part, and determine at least one image feature form matching the feature form type. The server may perform feature extraction on the biological part image based on the at least one image feature form, to obtain respective form features of pixels in the biological part image. The server may obtain a biological part feature of the to-be-recognized user based on the respective form features of the pixels. The server may perform feature matching on the biological part feature of the to-be-recognized user and registered part features, to obtain feature matching results, and determine an identity recognition result of the to-be-recognized user based on the feature matching results.

In the foregoing identity recognition method, the biological part image acquired for the target part of the to-be-recognized user is obtained; the respective form features of the pixels are extracted from the biological part image based on the at least one image feature form matching the feature form type of the target part, where the image feature form is obtained after respective distribution positions of the pixels targeted by each feature extraction in the pixels are combined; the biological part feature of the to-be-recognized user is obtained based on the respective form features of the pixels; and feature matching is performed on the biological part feature and the registered part features of the registered users, and the identity recognition result of the to-be-recognized user is determined based on the feature matching results. In an identity recognition process, the respective form features of the pixels are extracted based on the at least one image feature form matching the feature form type of the target part, so that expression pertinence of the biological part feature carried by the target part is enhanced and the biological part feature of the target part can be accurately obtained, thereby increasing accuracy of identity recognition based on the biological part feature of the target part.

In an exemplary embodiment, the target part is a palm, and the image feature form is a line form. The extracting respective form features of pixels from the biological part image based on at least one image feature form matching the feature form type includes: extracting the respective form features of the pixels from the biological part image based on a line form in at least one direction.

The target part is a palm, and the biological part image corresponding to the target part is a palm image. The feature form type of the palm includes a feature form of a palm print or a palm vein, which may be specifically a line form. The palm print refers to texture information of the palm from an end of a finger to a wrist, and includes various palm print features such as a main line, a wrinkle, a fine texture, a ridge end, and a branch point that may be configured for performing identity recognition. The palm print feature is a feature reflected by the texture information of the palm, which may be extracted from the palm image obtained by photographing the palm. Different users usually correspond to different palm print features, that is, palms of the different users have different texture features. Therefore, identity recognition processing on the different users may be implemented based on the palm print features. The palm vein refers to vein information of the palm, which is configured for reflecting vein line information in the palm of a human body and has a liveness recognition capability. A palm vein image may be photographed by using an infrared camera. A palm vein feature is a vein feature of the palm analyzed based on the palm vein. Different users usually correspond to different palm vein features, that is, the different users have different vein features. Identity recognition processing on the different users may also be implemented based on the palm vein feature.

Biological feature information of the palm print or the palm vein of the palm is usually reflected by a palm print line or a vein line. When the feature form type of the palm is a line form, the image feature form matching the feature form type is also a line form. For feature extraction of the line form, different directions may be included, so that different types of line forms may be divided. For example, the line form may include a horizontal direction, a vertical direction, and various directions that form specific angles with the horizontal direction. Line forms in different directions may be used as different types of line form, so that feature extraction may be performed based on the line forms in the different directions.

For example, for the palm image, the server may determine a line form in at least one direction. The line form is matched with the feature form type of the palm. The server may perform feature extraction on the biological part image based on the determined line form in the at least one direction, to obtain the respective form features of the pixels in the biological part image. For example, the server may determine a line feature extraction unit corresponding to the line form in each direction, and performs feature extraction on the biological part image based on the line feature extraction unit, to obtain the respective form features of the pixels in the biological part image. As shown in FIG. 5, the server may determine to perform feature extraction on the biological part image by using one of the feature extraction unit A, the feature extraction unit B, the feature extraction unit C, and the feature extraction unit D.

In this embodiment, for the biological part image of a palm, a feature form type of the palm is a line form. The server performs feature extraction on the biological part image based on the line form in at least one direction, to obtain the respective form features of the pixels in the biological part image. Therefore, feature extraction may be performed on the palm image based on the line form in the at least one direction, so that expression pertinence of the palm feature is enhanced and a palm feature can be accurately obtained, thereby increasing accuracy of identity recognition based on the palm feature.

In an exemplary embodiment, the extracting the respective form features of the pixels from the biological part image based on a line form in at least one direction includes: extracting, from the biological part image based on line forms in at least two directions, direction form features of the pixels respectively corresponding to the line forms in the at least two directions; fusing, for each pixel of the pixels, the direction form features respectively of the pixel respectively corresponding to the line forms in the at least two directions, to obtain a direction fusion feature of the pixel; and obtaining the respective form features of the pixels based on the direction fusion features of the pixels.

The line forms in different directions correspond to different line form types, and may respectively correspond to different feature extraction manners. When feature extraction is performed on the biological part image by using at least two image feature forms, for each pixel, direction form features respectively corresponding to the at least two image feature forms are obtained. For example, when feature extraction is performed on the biological part image based on the line forms in the horizontal direction and in the vertical direction, for each pixel in the biological part image, a direction fusion feature corresponding to the line form in the horizontal direction and a direction fusion feature corresponding to the line form in the vertical direction may be obtained. The direction fusion feature is a feature obtained by fusing the direction form features of a pixel corresponding to the line forms in various directions. Specifically, fusion may be performed in a weighted fusion manner, and the form feature of a corresponding pixel may be obtained based on the direction fusion feature.

Specifically, for a palm image, the server may determine line forms in at least two directions, and perform feature extraction on the biological part image based on the line forms in the at least two directions, to obtain the direction form features respectively corresponding to the pixels in the biological part image, where the pixel includes a direction form feature respectively corresponding to each line form of the line forms in the at least two directions. For example, when the line form includes five directions, after feature extraction is performed on the biological part image based on the line forms in the five directions, for each pixel in the biological part image, for example, for a pixel A, the pixel A includes a direction form feature corresponding to the line form in each direction, that is, the pixel A includes five direction form features. In specific implementation, the server may determine a line feature extraction unit corresponding to the line form in each direction, and perform feature extraction on the biological part image based on the line feature extraction unit, to obtain the respective form features of the pixels in the biological part image. As shown in FIG. 5, the server may determine to perform feature extraction on the biological part image by using at least two of the feature extraction unit A, the feature extraction unit B, the feature extraction unit C, and the feature extraction unit D.

For each pixel from which the direction form features are extracted in the biological part image, the server fuses the direction form features of the pixel, to obtain the direction fusion feature of the pixel. After the pixels are traversed, the respective direction fusion features of the pixels are obtained. In a specific application, for each pixel, the server may perform average fusion or weighted fusion on the direction form features of the pixel, to obtain the direction fusion feature of the pixel. The server may obtain the respective form features of the pixels based on the direction fusion features of the pixels. Specifically, the server may directly use the respective direction fusion features of the pixels as the respective form features; or the server may perform further feature mapping processing on the respective direction fusion features of the pixels respectively, to obtain the respective form features of the pixels.

In this embodiment, for the biological part image of the palm, the feature form type of the palm is the line form. The server performs feature extraction on the biological part image based on the line forms in at least two directions, to obtain the respective direction form features of the pixels in the biological part image, performs fusion on the respective direction form features of the pixels to obtain the direction fusion features, and obtains the respective form features based on the respective direction fusion features of the pixels. Therefore, feature extraction may be performed on the palm image based on the line forms in various directions, and extraction results corresponding to the line forms in the various directions are fused, so that the palm feature can be accurately obtained, thereby improving accuracy of identity recognition based on the palm feature.

In an exemplary embodiment, the extracting respective form features of pixels from the biological part image based on at least one image feature form matching the feature form type includes: determining at least one image feature form matching the feature form type in at least one image feature scale; and extracting the respective form features of the pixels from the biological part image based on the at least one image feature form in the at least one image feature scale.

The image feature scale represents an image pixel range covered during each feature extraction. Different image feature scales may cover different pixel ranges. A larger value of the image feature scale indicates a larger quantity of pixels targeted by each feature extraction, that is, a larger quantity of feature extraction coverage pixels during each feature extraction. The value of the image feature scale may be flexibly set according to an actual requirement. A plurality of values of the image feature scale may also be set. The image feature scale reflects the quantity of feature extraction coverage pixels during each feature extraction performed on the biological part image. The image feature form reflects distribution positions of the feature extraction coverage pixels during each feature extraction performed on the biological part image. Therefore, an effective form feature of the biological part image may be fully extracted by combining the image feature scale and the image feature form.

Specifically, the server determines at least one image feature scale, and may determine at least one corresponding image feature form for each image feature scale, where the image feature form matches the feature form type of the target part. For example, it may be determined that the image feature scale may include a total of three scales of 4*4, 8*8, and 16*16, and the image feature form may include line forms in 10 directions. The server performs feature extraction on the biological part image based on the at least one image feature form in the determined at least one image feature scale, to obtain the respective form features of the pixels in the biological part image. In specific implementation, for each pixel from which the form feature is extracted in the biological part image, if a quantity of form features corresponding to the pixel is 1, for example, feature extraction is performed based on one image feature form in one image feature scale, a form feature corresponding to the image feature scale and the image feature form may be obtained for the pixel. Therefore, the server may determine the form feature as the form feature corresponding to the corresponding pixel. If a quantity of form features corresponding to the pixel is more than 1, for example, a quantity of types of at least one of the image feature scale or the image feature form is more than one, a plurality of form features may be obtained for the pixel. Therefore, the server may fuse the plurality of form features, to obtain the form feature corresponding to the corresponding pixel.

In a specific application, the server may determine a feature extraction unit corresponding to at least one image feature form in each image feature scale, and perform feature extraction on the biological part image based on the feature extraction unit, to obtain the respective form features of the pixels in the biological part image. As shown in FIG. 4, the annular feature extraction unit 1 and the annular feature extraction unit 2 correspond to different image feature scales. The server may determine at least one from the feature extraction unit 1 and the feature extraction unit 2, to perform feature extraction on the biological part image.

In this embodiment, the server performs feature extraction on the biological part image based on at least one image feature form in at least one image feature scale, to obtain the respective form features of the pixels in the biological part image. Feature extraction may be performed according to an actual scale requirement, which is beneficial to enhancing expression pertinence of a target part feature with reference to a feature scale, so that the biological part feature of the target part can be accurately obtained, thereby improving accuracy of identity recognition based on the biological part feature of the target part.

In an exemplary embodiment, the extracting the respective form features of the pixels from the biological part image based on the at least one image feature form in the at least one image feature scale includes: extracting, from the biological part image based on at least one image feature form in at least two image feature scales, scale form features of each pixel respectively corresponding to the at least two image feature scales; fusing, for each pixel of the pixels, the scale form features of the pixel respectively corresponding to the at least two image feature scales, to obtain a scale fusion feature of the pixel; and obtaining the respective form features of the pixels based on the scale fusion features of the pixels.

At least two image feature scales are included, and each image feature scale may correspond to at least one image feature form, thereby implementing multi-scale feature extraction. For example, when there are M types of image feature scales and there are N types of image feature forms, M*N types of feature extraction may be implemented. That is, M*N form features may be extracted for each pixel on which feature extraction is performed in the biological part image. The scale form feature is a form feature extracted based on one image feature form in one image feature scale, and each scale form feature corresponds to one image feature form in one image feature scale. For each pixel on which feature extraction is performed in the biological part image, a quantity of scale form features of the pixel is a product of a quantity of types of the image feature scales and a quantity of types of the image feature forms. For each pixel on which feature extraction is performed in the biological part image, the scale fusion feature of the pixel is a feature obtained by fusing a plurality of scale form features corresponding to the pixel, and the form feature of the pixel may be obtained based on the scale fusion feature.

Specifically, the image feature scale determined by the server may include at least two types, and at least one image feature form may be included in each image feature scale. The server performs feature extraction on the biological part image based on the determined at least one image feature form in each image feature scale, to obtain the scale form feature of each pixel, where each scale form feature corresponds to one image feature form in one image feature scale. For example, for an image feature scale 1, an image feature scale 2, and an image feature scale 3, in each image feature scale, a corresponding scale form feature may be extracted for a pixel A in the biological part image, which may specifically include a scale form feature a1 extracted in the image feature scale 1, a scale form feature a2 extracted in the image feature scale 2, and a scale form feature a3 extracted in the image feature scale 3. In each image feature scale, feature extraction of at least one image feature form may be performed. For example, an image feature form 1, an image feature form 2, and an image feature form 3 may be included. Therefore, for the pixel A in the biological part image, scale form features respectively corresponding to the three image feature forms may be extracted respectively in each image feature scale. For example, the scale form feature a1 extracted in the image feature scale 1 may include a scale form feature a11, a scale form feature a12, and a scale form feature a13, where the scale form feature a11 is extracted based on the image feature form 1, the scale form feature a12 is extracted based on the image feature form 2, and the scale form feature a13 is extracted based on the image feature form 3. A plurality of image feature scales are included, and therefore, each pixel includes a plurality of scale form features. For each pixel of the pixels, the server may fuse the scale form features of the pixel, for example, may perform average fusion, to obtain a scale fusion feature of the pixel. After traversing the pixels to obtain the scale fusion features of the pixels, the server may obtain the respective form features based on the scale fusion features of the pixels. For example, the server may directly use the scale fusion features of the pixels as the respective form features, or may perform further feature mapping processing on the scale fusion features of the pixels, to obtain the respective form features of the pixels.

In this embodiment, the server performs feature extraction on the biological part image based on the at least one image feature form in the at least two image feature scales, to obtain the respective scale form features of each pixel in the biological part image, obtain the scale fusion feature by fusing the respective scale form features of the pixel, and obtain the form feature based on the scale fusion feature of the pixel, so that feature extraction may be performed on the biological part image based on a plurality of scales. By fusing feature extraction results in the plurality of scales, the biological part feature of the target part can be accurately obtained, thereby improving accuracy of identity recognition based on the biological part feature of the target part.

In an exemplary embodiment, the extracting the respective form features of the pixels from the biological part image based on at least one image feature form matching the feature form type includes: extracting the respective form features of the pixels from the biological part image by using a convolutional network in a pre-trained feature extraction model, where the convolutional network is configured to perform feature extraction on the biological part image based on the at least one image feature form matching the feature form type of the target part.

The feature extraction model may be pre-trained based on sample data. The feature extraction model may be a model trained based on various neural network algorithms, and the neural network algorithm may specifically include, but is not limited to, a convolutional neural network (CNN) algorithm, a recurrent neural network (RNN) algorithm, a transformer model (Transformer) algorithm, a multilayer perceptron (MLP) algorithm, a residual network (ResNets) algorithm, and the like. The feature extraction model may include a convolutional network. The convolutional network is configured to perform feature extraction based on the at least one image feature form matching the feature form type of the target part, that is, the form feature of an input image is extracted by using the convolutional network in the feature extraction model, to perform feature extraction on the input image based on the at least one image feature form.

For example, the server may obtain the pre-trained feature extraction model, and extract the respective form features of the pixels from the biological part image by using the convolutional network that is in the pre-trained feature extraction model and configured to perform feature extraction based on the at least one image feature form matching the feature form type of the target part. In a specific application, each image feature form may correspond to a convolution kernel, to implement feature extraction processing of the image feature form by using the corresponding convolution kernel. That is, feature extraction on the biological part image may be implemented by using at least one convolution kernel. In the convolutional network, at least one convolution kernel may be included. The biological part image is input into the convolutional network, to implement, by using the at least one convolution kernel, feature extraction processing of the corresponding image feature form to obtain the respective form features of the pixels.

Further, the obtaining a biological part feature of the to-be-recognized user based on the respective form features of the pixels includes: extracting the biological part feature of the to-be-recognized user from the respective form features of the pixels by using a part feature extraction network in the feature extraction model.

The feature extraction model further includes a sub-network of the part feature extraction network, to perform further feature extraction on the respective form features of the pixels by using the part feature extraction network to obtain the biological part feature of the to-be-recognized user. The part feature extraction network may be constructed by selecting an artificial neural algorithm according to an actual requirement, and may be trained based on sample data. For example, the part feature extraction network may be constructed based on at least one algorithm of the CNN algorithm, the RNN algorithm, the Transformer algorithm, the MLP algorithm, the ResNets algorithm, or the like.

For example, the server may input the respective form features of the pixels to the part feature extraction network in the part feature extraction model, and the part feature extraction network in the feature extraction model performs feature extraction on the form features of the pixels, to obtain the biological part feature of the to-be-recognized user. For example, the part feature extraction network may splice the input respective form features of the pixels. Specifically, the respective form features of the pixels may be spliced based on the respective distribution positions of the pixels in the biological part image, to obtain the form feature of the biological part image, and feature extraction is performed on the form feature of the biological part image, to obtain the biological part feature of the to-be-recognized user.

In this embodiment, the respective form features of the pixels are extracted from the biological part image, by using the convolutional network in the pre-trained feature extraction model, based on the at least one image feature form matching the feature form type of the target part, and the biological part feature of the to-be-recognized user is extracted from the respective form features of the pixels by using the part feature extraction network in the feature extraction model, so that efficient and accurate feature extraction processing may be implemented based on an artificial neural network model, thereby facilitating improving the processing efficiency and accuracy of identity recognition.

In an exemplary embodiment, the feature extraction model is obtained by using operations of model training. The operations of model training include: obtaining a plurality of biological part image samples; extracting sample form features of sample pixels from the biological part image samples by using a convolutional network in a to-be-trained feature extraction model; extracting a biological part sample feature from the sample form features of the sample pixels by using a part feature extraction network of the to-be-trained feature extraction model; determining a training loss based on the biological part sample feature and the sample form features; and updating the convolutional network and the part feature extraction network in the to-be-trained feature extraction model separately based on the training loss, and continuing to train the convolutional network and the part feature extraction network until training is completed, to obtain a trained feature extraction model.

The biological part image sample is sample data for training the feature extraction model, and the biological part image sample may carry an identity identification label, to determine feature extraction performance of the feature extraction model based on the identity identification label. The sample form feature is extracted by the convolutional network in the to-be-trained feature extraction model based on the biological part image sample, and the convolutional network may perform feature extraction on the input biological part image sample based on the at least one image feature form matching the feature form type of the target part. The biological part sample feature is a biological feature extracted by using the part feature extraction network in the to-be-trained feature extraction model. The training loss is obtained based on the biological part sample feature and the sample form feature. The feature extraction performance of the feature extraction model may be evaluated based on the training loss, to update the feature extraction model and improve the feature extraction performance of the feature extraction model. The biological part sample feature may reflect the feature extraction performance of the part feature extraction network, and the sample form feature may reflect the feature extraction performance of the convolutional network.

For example, when the feature extraction model is trained, the server may obtain a plurality of biological part image samples, and the biological part image samples may be collected based on the target part of the user. The server performs feature extraction on the biological part image samples by using the convolutional network in the to-be-trained feature extraction model, to extract the sample form features of the sample pixels from the biological part image samples. The server performs further feature extraction on the sample form features of the sample pixels by using the part feature extraction network in the to-be-trained feature extraction model, to obtain the biological part sample feature. The server determines the training loss based on the biological part sample feature and the sample form features, and updates a model parameter of the to-be-trained feature extraction model based on the training loss. Specifically, the server updates respective network parameters of the convolutional network and the part feature extraction network in the to-be-trained feature extraction model, for example, updates weight parameters in the networks, and continues to train by using an updated feature training model until training is completed, to obtain the trained feature extraction model. For example, when the training reaches a preset quantity of training times, the feature extraction model satisfies a convergence condition, or the feature extraction performance of the feature extraction model satisfies a performance requirement, it may be considered that a training end condition is satisfied. In this way, the training is completed, and the trained feature extraction model is obtained based on the feature extraction model when the training is completed.

In this embodiment, the server trains, based on the biological part image samples, the feature extraction model which includes the convolutional network and the part feature extraction network, determines the training loss based on the sample form features reflecting a feature extraction capability of the convolutional network and the biological part sample feature reflecting a feature extraction capability of the feature extraction network, and performs model update on the feature extraction mode based on the training loss, to ensure the respective feature extraction performance of the convolutional network and the part feature extraction network, thereby improving the feature extraction performance of the feature extraction model and facilitating improving the accuracy of identity recognition.

In an exemplary embodiment, the determining a training loss based on the biological part sample feature and the sample form features includes: obtaining a part feature extraction loss based on the biological part sample feature; determining a negative sample pair, where the negative sample pair includes biological part image samples carrying different identity labels; obtaining a sample pair loss based on the sample form features of the biological part image samples in the negative sample pair; and obtaining the training loss based on the part feature extraction loss and the sample pair loss.

The part feature extraction loss is obtained based on the biological part sample feature, and is configured for reflecting the feature extraction performance of the part feature extraction network, which may be specifically calculated by using various loss algorithms. For example, the part feature extraction loss may be obtained based on at least one of loss algorithms such as an arcface (additive angular margin loss) algorithm, a mean squared error (MSE) algorithm, and a cross entropy algorithm. The negative sample pair includes biological part image samples carrying different identity labels, that is, the biological part image samples in the negative sample pair respectively correspond to different users. The sample pair loss is obtained based on the sample form features of the biological part image samples in the negative sample pair, which may be specifically calculated by using various loss algorithms. For example, the sample pair loss may be obtained by using an algorithm such as an L1 loss (absolute value loss), and an L2 loss (mean square error loss). The training loss is obtained based on the part feature extraction loss and the sample pair loss, and may be specifically obtained by fusing the part feature extraction loss and the sample pair loss.

Specifically, the server may obtain the part feature extraction loss based on the biological part sample feature, for example, may be calculated based on the biological part sample feature by using the arcface algorithm. The server determines the negative sample pair which includes biological part image samples carrying different identity labels, and determines the sample form features of the biological part image samples in the negative sample pair. The server obtains the sample pair loss based on the sample form features of the biological part image samples in the negative sample pair. For example, the sample pair loss may be calculated based on the L1 loss algorithm and based on the sample form features of the biological part image samples in the negative sample pair. The server may obtain the training loss based on the part feature extraction loss and the sample pair loss. Specifically, the server may obtain the training loss based on a sum of the part feature extraction loss and the sample pair loss, to update the model parameter of the feature extraction model by using the training loss.

In this embodiment, the server obtains, based on the sample form features, the part feature extraction loss reflecting the feature extraction capability of the part feature extraction network, obtains, based on the sample form features of the biological part image samples in the negative sample pair, the sample pair loss reflecting the feature extraction capability of the convolutional network, obtains the training loss based on the part feature extraction loss and the sample pair loss, and performs model update based on the training loss. Therefore, the respective feature extraction performance of the convolutional network and the part feature extraction network may be ensured, thereby improving the feature extraction performance of the feature extraction model and facilitating improving the accuracy of identity recognition.

In an exemplary embodiment, the obtaining a biological part feature of the to-be-recognized user based on the respective form features of the pixels includes: splicing the respective form features of the pixels based on the respective distribution positions of the pixels in the biological part image, to obtain a form feature of the biological part image; and performing feature extraction on the form feature of the biological part image, to obtain the biological part feature of the to-be-recognized user.

The distribution position refers to a spatial position of the pixel in the biological part image. For example, the server may determine the respective distribution positions of the pixels in the biological part image, and splice the respective form features of the pixels based on the respective distribution positions, to obtain the form feature of the biological part image. The server performs further feature extraction based on the form feature of the biological part image, to obtain the biological part feature of the to-be-recognized user. In a specific application, the server may perform feature extraction on the form feature of the biological part image by using the part feature extraction network in the pre-trained feature extraction model. For example, the form feature of the biological part image may be input to the part feature extraction network of the feature extraction model, to obtain the biological part feature of the to-be-recognized user.

In this embodiment, the server splices the respective form features of the pixels and performs feature extraction on the obtained form feature of the biological part image, to obtain the biological part feature of the to-be-recognized user. The respective form features of the pixels may be integrated, which facilitates improving an expression capability of the biological part feature, thereby improving the accuracy of identity recognition.

In an exemplary embodiment, the extracting respective form features of pixels from the biological part image based on at least one image feature form matching the feature form type includes: determining a region of interest from the biological part image; determining the at least one image feature form matching the feature form type; and extracting the respective form features of the pixels in the region of interest based on the at least one image feature form.

The region of interest is an image region that is determined from the biological part image and on which biological part feature extraction needs to be performed. For example, the server may determine the region of interest from the biological part image. For example, biological part recognition may be performed on the biological part image, to determine a region including the target part as the region of interest. The server may determine at least one image feature form matching the feature form type of the target part. Specifically, the server may determine the feature form type of the target part, and determine the at least one matching image feature form based on the feature form type. The server performs feature extraction on the region of interest based on the determined at least one image feature form, to obtain the respective form features of the pixels in the region of interest.

In this embodiment, the server determines the region of interest from the biological part image, and performs feature extraction based on the region of interest to perform identity recognition, so that a data volume of feature extraction processing may be reduced, thereby improving processing efficiency of identity recognition.

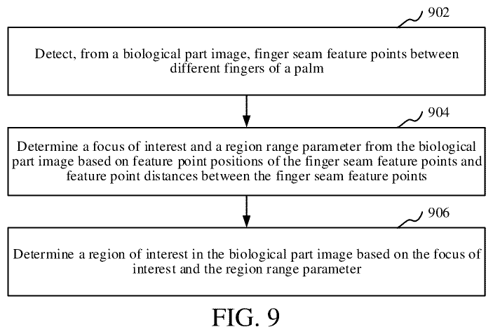

In an exemplary embodiment, the target part is a palm, and as shown in FIG. 9, the processing of determining a region of interest, that is, the determining a region of interest from the biological part image includes operation 902 to operation 906.

Operation 902: Detect, from the biological part image, finger seam feature points between different fingers of the palm.

The target part is a palm, the biological part image is a palm image, and the biological part feature that needs to be extracted is a palm feature, which may specifically include at least one of a palm print feature or a palm vein feature. The finger seam feature point may be a feature point for distinguishing each finger, which may be specifically a connection point at a palm print part between fingers. Specifically, the server may perform palm feature point recognition on the biological part image, to recognize the finger seam feature points between the fingers of the palm. For example, the server may specifically recognize connection points between adjacent fingers of a thumb, an index finger, a middle finger, a ring finger, and a little finger at the palm, to obtain the finger seam feature points.

Operation 904: Determine a focus of interest and a region range parameter from the biological part image based on feature point positions of the finger seam feature points and feature point distances between the finger seam feature points.

The feature point position refers to a spatial position of the finger seam feature point in the biological part image, and the feature point distance refers to a distance between the feature point positions of the finger seam feature points. The focus of interest is a feature point of a to-be-determined region of interest, which may be specifically a vertex, a circle center, a center point, or the like of the to-be-determined region of interest. The region range parameter is configured for describing a range of the to-be-determined region of interest, which may specifically include a parameter such as a side length or a radius. Specifically, the server may determine the feature point positions of the finger seam feature points in the biological part image, and determine, based on the feature point positions, the feature point distances between the finger seam feature points. The server determines the focus of interest and the region range parameter in the biological part image based on the feature point positions and the feature point distances. For example, the server may determine a circle center and a radius based on the feature point positions and the feature point distances, so that a circular region of interest which is determined based on the circle center and the radius can cover the finger seam feature points and a palm region.

Operation 906: Determine the region of interest in the biological part image based on the focus of interest and the region range parameter.

Specifically, the server determines the region of interest in the biological part image based on the focus of interest and the region range parameter. For example, when the focus of interest is a center point, and the region range parameter is a side length, a polygonal region of interest may be constructed by using the focus of interest as a center point and by using the region range parameter as a geometric side length. For another example, when the focus of interest is a center (e.g., circle center), and the region range parameter is a radius, a circular region of interest may be constructed by using the focus of interest as a circle center and by using the region range parameter as a radius.

In this embodiment, the server detects the finger seam feature points between the fingers of the palm in the biological part image, determines the focus of interest and the region range parameter based on the feature point positions of the finger seam feature points and the feature point distances between the finger seam feature points, and determines the region of interest in the biological part image based on the focus of interest and the region range parameter. Therefore, it may be ensured that the region of interest can cover the palm region, so that a data volume of feature extraction processing is reduced while accuracy of biological feature extraction is ensured, thereby improving processing efficiency of identity recognition.

In an exemplary embodiment, the performing feature matching on the biological part feature and registered part features, to obtain feature matching results, and determining an identity recognition result of the to-be-recognized user based on the feature matching results includes: obtaining registered part features of registered users; determining feature similarities between the biological part feature and the registered part features separately; and determining the identity recognition result of the to-be-recognized user based on the feature similarities.

The registered part feature is a biological part feature obtained by performing identity registration on a biological part image corresponding to the target part of a registered user. The feature similarity is calculated based on the biological part feature and the registered part feature, which may specifically include at least one of various forms such as a cosine similarity, a Euclidean distance, a Manhattan distance, and a Minkowski distance.

Specifically, the server may obtain the pre-stored registered part features of the registered users, and perform similarity calculation on the biological part feature and the registered part features, to determine the feature similarities between the biological part feature and the registered part features. The server obtains the identity recognition result of the to-be-recognized user based on the feature similarities. For example, the server may determine a registered user corresponding to a registered part feature having a highest similarity as the identity recognition result of the to-be-recognized user. In addition, a similarity threshold may alternatively be set. When a similarity value exceeds the similarity threshold, it is considered that the features match each other, and a registered user corresponding to a registered part feature having a highest similarity is determined as the identity recognition result of the to-be-recognized user. When the similarity value is less than the similarity threshold, it may be considered that the features do not match each other, that is, the to-be-recognized user does not belong to the registered users who have completed registration in advance.

In this embodiment, the server determines the identity recognition result of the to-be-recognized user based on the feature similarities between the biological part feature of the to-be-recognized user and the registered part features of the registered users, so that effective identity recognition processing may be implemented by using the biological part feature, thereby ensuring accuracy of identity recognition.

This disclosure further provides an application scenario. The foregoing identity recognition method is applied to the application scenario. Specifically, application of the identity recognition method in the application scenario is as follows:

A palm print recognition technology is a new generation biological feature recognition technology following a facial recognition technology, and currently, has been applied to fields such as mobile payment and identity verification. Compared with the facial recognition technology, the palm print recognition technology is configured for recognizing identity information of different users based on images of palm print regions. Because the palm print is covert, the palm print recognition technology is more beneficial to protecting user privacy, and is not affected by factors such as a mask, makeup, and sunglasses.

Existing palm print recognition technologies may be generally classified into three types. A first type is geometrical feature-based palm print recognition. Palm print recognition is mainly performed by recognizing a geometrical shape on the palm, such as a finger spacing, a finger width, and a palm length. Specifically, when a geometrical feature-based palm print recognition solution is implemented, image preprocessing is performed, specifically, operations, including denoising, enhancement, and binarization, are performed on an input palm print image; geometrical feature extraction is performed, specifically, the geometrical feature of the palm, such as the finger width, the finger spacing, or the palm length is calculated; and mode matching is performed, specifically, mode matching is performed on the extracted geometrical feature and templates in a database, to recognize an individual identity. The geometrical feature-based palm print recognition method is relatively robust to a relatively low-resolution image and environmental interference, but has limited recognition precision.

A second type is texture feature-based palm print recognition. The texture feature-based method focuses on a feature of skin texture on a palm surface, such as a directional field and a Gabor filter. When a texture feature-based palm print recognition solution is implemented, image preprocessing is performed, specifically, operations, including denoising, enhancement, and filtering, are performed on an input palm print image; texture feature extraction is performed, specifically, a signal processing method, such as the directional field and the Gabor filter, is used to extract a texture feature from the preprocessed image; and feature matching is performed, specifically, palm print recognition is implemented by comparing the input image with texture features in a database. The texture feature-based palm print recognition method uses signal processing and machine learning technologies to extract and match the palm print texture feature. The texture feature-based method has relatively good robustness and recognition precision for a complex scenario.

A third type is deep learning-based palm print recognition. Specifically, a modern deep learning technology, such as a convolutional neural network (CNN), is used to perform end-to-end feature learning and recognition on a palm image. When a deep learning-based palm print recognition solution is implemented, image preprocessing is performed, specifically, operations, such as denoising, enhancement, and normalization, are performed on an input palm print image; deep learning model training is performed, specifically, a deep convolutional neural network is used to train a labeled palm print image and learn a hierarchical feature of a palm print; and palm print recognition is performed, specifically, the input image is preprocessed and then input to a pre-trained model, to perform palm print recognition. The deep learning-based palm print recognition method may automatically learn a hierarchical feature expression of the palm image, thereby improving accuracy and robustness of palm print recognition.

However, in a mobile payment scenario, there is a very large number of users, which includes many highly similar samples. In existing geometrical feature-based, texture feature-based, and deep learning-based methods, the palm feature is extracted based on a square convolution kernel. Because the palm feature is mainly a line feature, feature extraction effects of the palm feature are all poor.

Feature information of the palm is mainly concentrated in the palm print line. Therefore, extraction of a palm print line feature is very important for distinguishing different palms. For the problem in the existing methods, this embodiment provides a linear convolution-based palm print feature extraction method, which fully learns the line feature of the palm print line, to distinguish different palm print lines. For a form of the palm print line feature, this embodiment provides a linear convolution-based palm print feature extraction method. By designing a linear convolutional feature extractor, an effect of extracting a line feature by a model is effectively improved, and a capability of distinguishing different palms by the model is effectively improved, thereby improving accuracy of palm print recognition. This embodiment provides a linear convolution-based palm print recognition method: in a first operation, a detection model is used to detect positions of three finger seam key points of an index finger, a middle finger, and a ring finger of a palm; in a second operation, a region of interest of the palm is extracted based on the positions of the three finger seam key points; in a third operation, palm print feature extraction is performed on the region of interest by using a multi-scale linear convolution kernel; in a fourth operation, linear extracted features extraction features in different scales are fused; and in a fifth operation, feature constraint is performed by using a pairwise loss function. In this embodiment, multi-scale linear convolution is introduced, so that the line feature of the palm print can be extracted more effectively, and pixel-level orientation map comparison is added, so that highly similar samples can be better distinguished, thereby improving accuracy of palm print recognition.

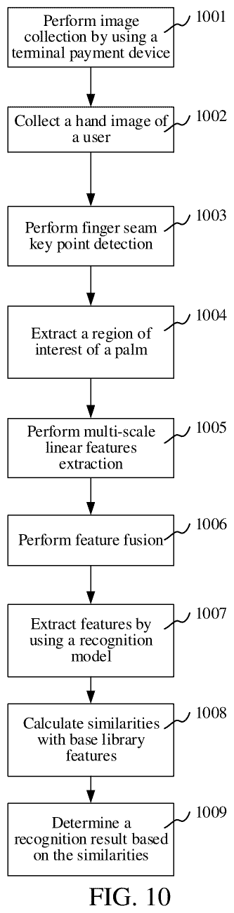

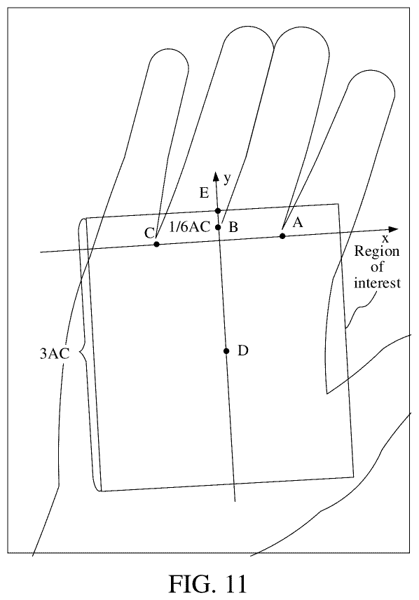

The palm print recognition technology has a wide prospect of use in commercial scenarios such as mobile payment and identity verification. This embodiment provides a linear convolution-based palm print feature extraction method, to determine an identity of a user by performing feature matching based on a palm image of the user. As shown in FIG. 10, a payment-oriented palm print recognition processing process includes the following operations: Operation 1001: Perform image collection by using a terminal payment device. Operation 1002: Collect a hand image of a user. Operation 1003: Perform finger seam key point detection. Specifically, a detection model may be used to detect three finger seam key points of a hand of the user. Operation 1004: Extract a region of interest of a palm. Specifically, the region of interest of the palm may be extracted based on the hand image and key point positions. Operation 1005: Perform multi-scale line feature extraction. Specifically, a multi-scale linear model is used to extract features from the region of interest of the palm. Operation 1006: Perform feature fusion. Specifically, line features in a plurality of scales are fused. Operation 1007: Extract features by using a recognition model. Specifically, the recognition model is used to infer multi-scale information. Operation 1008: Calculate similarities with base library features. Specifically, cosine similarities between a spliced feature and the base library features are calculated. Operation 1009: Determine a recognition result based on the similarities. Specifically, identity information corresponding to a base library image having a highest similarity is determined as a target user.

Palm region detection is performed on the collected image. Specifically, a target detection technology is used to locate finger seam points, to extract a palm region image from the image. Specifically, for extraction processing on the region of interest of the palm, as shown in FIG. 11, finger seam key points are first located. Specifically, three finger seam key points of an index finger A, a middle finger B, and a ring finger C are detected by using a finger seam point target detector based on a You Only Look Once (YOLOv2) algorithm. Then, a local coordinate system is determined. Specifically, an x axis of the local coordinate system is determined based on the key point A and the key point C, a y axis perpendicular to the x axis is determined based on the third point B, and a palm print center point D of is found along a negative direction of the y axis at a distance of a length of AC from a coordinate origin, where a length of DE is equal to 6/5 of the length of AC. Finally, ROI extraction is performed. Specifically, a distance from the point A to the point C is multiplied by 3/2 as ½ side length d of a region of interest (ROI). By using the point D as a center point and 2d as a side length, the ROI is extracted as an input of the recognition model. As shown in FIG. 11, a square region with the point D as a center point and 3AC as a side length is a determined as the ROI.

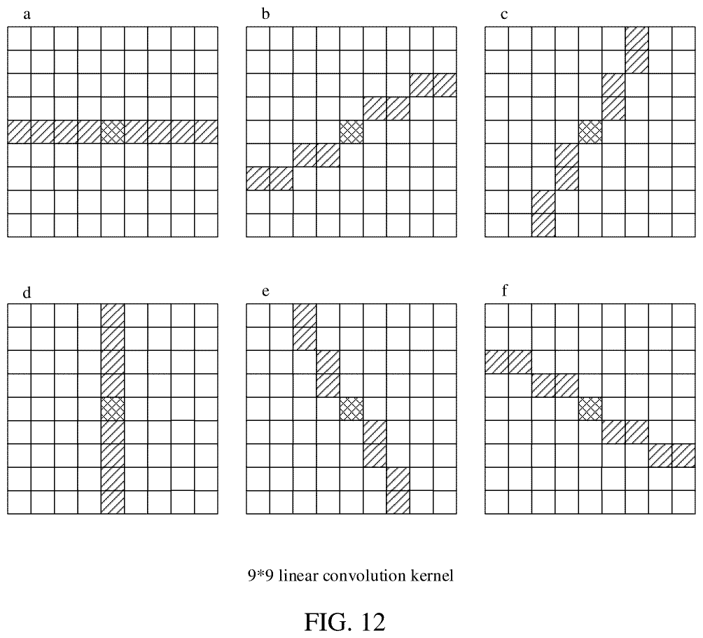

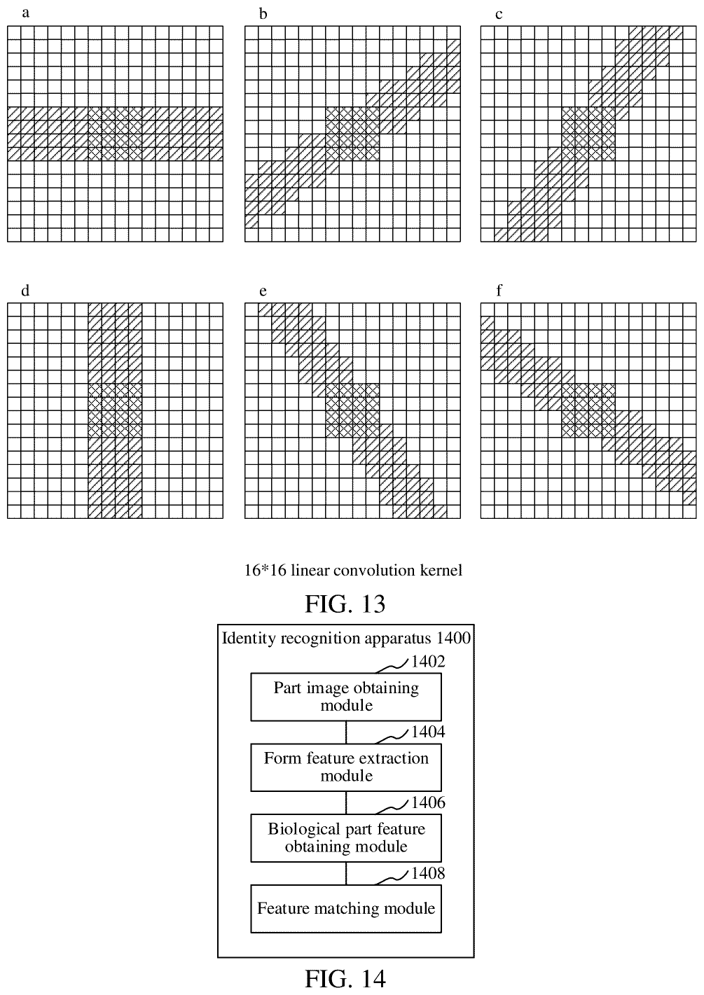

For model training processing, scales of local regions of interest extracted from sample data are all resized to a same scale of 224*224. Further, for a line distribution situation of palm print lines, linear convolution kernels in different scales and in different directions may be set, which are configured to extract palm line features in the different scales and in the different directions. As shown in FIG. 12, for a 9*9 linear convolution, using a kernel central pixel of a convolution kernel as an origin, a linear convolution weight is constructed along directions a, b, c, d, e, and f whose angles with a horizontal direction are 0 degree, 30 degrees, 60 degrees, 90 degrees, 120 degrees, and 150 degrees respectively. A width of the linear convolution weight is 1, and a width of a remaining part of the weight is 0. That is, a weight of a convolution unit filled with a line is 1, a convolution result thereof is valid, a weight of a blank convolution unit not filled with a line is 0, and a convolution result thereof is 0. As shown in FIG. 13, for a 16*16 linear convolution, using a kernel central pixel as an origin, a linear convolution weight is constructed along directions a, b, c, d, e, and f whose angles with a horizontal direction are 0 degree, 30 degrees, 60 degrees, 90 degrees, 120 degrees, and 150 degrees. A width of the linear convolution weight is 4 and a width of a remaining part of the weight is 0.

Further, feature extraction is performed on the region of interest by using the linear convolution kernels in the different scales and in the different directions. A feature extraction result may be shown by the following formula:

$${y}_{i , j} = {\sum }_{m = 0}^{k - 1} {\sum }_{n = 0}^{k - 1} {x}_{i + m , j + n} * {ω}_{m , n} + b$$

y_{i,j} is a line feature obtained by extracting, based on a linear convolution kernel, a pixel in an it row and a j^{th} column in the input image, x_{i,j} represents a pixel value in the i^{th} row and the j^{th} column of the input image, and x_{i+m,j+n} is a pixel corresponding to an m^{th} row and an n^{th} column in a range of the linear convolution kernel. m is a width of the linear convolution kernel, n is a height of the linear convolution kernel, ω_{m,n} is a weight parameter corresponding to the m^{th} row and the n^{th} column of the linear convolution kernel, b is a bias, and k is the width of the linear convolution kernel, which is respectively 9 and 16 herein. In this way, 12 linear convolution results may be obtained for each pixel of the input image, specifically including 2 scales and 6 directions for each scale.

Further, for each pixel, averaging is performed on the 12 linear convolution results of the pixel, to represent a linear convolution fusion result of the pixel. Details are shown in the following formula:

$${y}_{i , j} = {avg}_{1}^{12} ( {y}_{i , j}^{m} )$$

y_{i,j} is a linear convolution fusion result and

$${y}_{i , j}^{m}$$

is a linear convolution result of each column.

Further, the linear convolution results of all pixels are spliced based on corresponding pixel positions, to obtain an orientation map orientation_map of the whole image, and the orientation map is used as an input of a subsequent feature extraction network, where the subsequent feature extraction network may be inception resnet50, and an output of the subsequent feature extraction network is a 512-dimensional feature feature_id.

Further, arcface is used to calculate a loss function between palm image features of different identities. On this basis, a negative sample pairwise pixel-level orientation map difference is added. Specifically, two palm images having inconsistent identities form negative samples, L1 loss functions between respective orientation maps are calculated, and a sum of L1 losses of all the negative samples is used as a pairwise loss. Details are shown in the following formula:

$$pairwise\_loss = {\sum }_{i = 1}^{n} \vert {orientation}_{{map}_{i}} , {orientation}_{{map}_{j}} \vert$$

n is a quantity of negative samples, orientationₘₐₚ_{ᵢ} is an orientation map of an i^{th} negative sample, and orientationₘₐₚ_{ⱼ} is an orientation map of a j^{th} negative sample.

A final loss function loss_final is obtained by adding an arcface loss and the pairwise loss. Details are shown in the following formula:

$$loss\_final = arcfac\_loss + pairwise\_loss$$

After calculation of the final loss function loss_final is completed, gradient back propagation is performed, and training is continued until the training is completed, to obtain a trained feature extraction network.

During identity recognition, a hand image of a user may be collected by using a camera of a terminal payment device; a detection model is used to detect three finger seam key points of a hand of the user; a region of interest of a palm is extracted based on the hand image and key point positions; multi-scale line features are extracted by using a multi-scale linear convolution; average fusion is performed on the multi-scale line features; the feature extraction network is used to extract an encoding vector of the palm print image feature; and cosine similarities between the encoding vector of the palm print image feature and the base library features are calculated, where a formula for calculating the cosine similarity is as follows:

$$im ( {vector}_{reg} , {vector}_{rec} ) = \frac{\vec{{vector}_{reg}} \times \vec{{vector}_{rec}}}{‖ {vector}_{reg} ‖ \times ‖ {vector}_{rec} ‖}$$

vector_{reg} and vector_{rec} respectively represent a registered base library feature and a recognized feature. A sample id having a highest similarity is used as a final recognition result, and the sample id is returned to the terminal payment device as an identity recognition result.

In a specific application, an effect of a high-similarity palm print fine-grained recognition algorithm is verified. The following Table 1 shows verification results of the linear convolution method of this embodiment on a twin dataset.

TABLE 1

| Method/Quantity of recognized | High-definition | Fuzzy twin |
|---|---|---|
| incorrect sample pairs | twin image | image |
| Arcface existing method | 37 | 46 |
| This embodiment | 0 | 0 |

To verify effectiveness of linear convolution feature extraction, forty pairs of twins' high-definition and fuzzy palm print images are used as high-similarity palm print images for testing, and the results are shown in Table 1. The left hand/right hand of the same pair of twins is used as a sample pair, which includes 3600 sample pairs in total. On the high-definition twin images, the arcface existing method has 37 pairs of samples with incorrect recognition results, and the method of this embodiment has no incorrectly recognized sample. On the fuzzy twin images, arcface has 46 pairs of incorrectly recognized samples, and the method of this embodiment has no incorrectly recognized sample set, reflecting the effectiveness of this method in recognizing highly similar samples.

Although the operations in the flowcharts involved in the foregoing embodiments are displayed sequentially as indicated by arrows, the operations are not necessarily performed sequentially as indicated by the arrows. Unless otherwise explicitly specified in this specification, execution of the operations is not strictly limited, and the operations may be performed in other sequences. In addition, at least a part of the operations in the flowcharts involved in the foregoing embodiments may include a plurality of operations or a plurality of stages. These operations or stages are not necessarily performed simultaneously, but may be performed at different moments. These operations or stages are not necessarily performed sequentially, but may be performed in turn or alternately with other operations or at least a part of operations or stages in the other operations.

Based on the same inventive concept, an embodiment of this disclosure further provides an identity recognition apparatus for implementing the foregoing identity recognition method. The implementation solution for resolving the problem provided by this apparatus is similar to the implementation solution recorded in the foregoing method. Therefore, for specific limitations in one or more embodiments of the identity recognition apparatus provided below, reference may be made to the foregoing limitations on the identity recognition method, and details are not described herein again.

In an embodiment, as shown in FIG. 14, an identity recognition apparatus 1400 is provided, applied to a computer device. The apparatus includes: a part image obtaining module 1402, a form feature extraction module 1404, a biological part feature obtaining module 1406, and a feature matching module 1408, where
the part image obtaining module 1402 is configured to obtain a biological part image acquired for a target part of a to-be-recognized user;
the form feature extraction module 1404 is configured to: determine a feature form type of the target part, and extract respective form features of pixels from the biological part image based on at least one image feature form matching the feature form type, where the image feature form is a form obtained after respective distribution positions of feature extraction coverage pixels are combined, and the feature extraction coverage pixels are pixels that are in the biological part image and targeted by each feature extraction;
the biological part feature obtaining module 1406 is configured to obtain a biological part feature of the to-be-recognized user based on the respective form features of the pixels; and
the feature matching module 1408 is configured to: perform feature matching on the biological part feature and registered part features, to obtain feature matching results, and determine an identity recognition result of the to-be-recognized user based on the feature matching results, where the registered part feature is a biological part feature obtained by performing identity registration on a biological part image corresponding to the target part of a registered user.

In an embodiment, the target part is a palm, and the image feature form is a line form; and the form feature extraction module 1404 is further configured to extract the respective form features of the pixels from the biological part image based on the line form in at least one direction.

In an embodiment, the form feature extraction module 1404 is further configured to: extract, from the biological part image based on line forms in at least two directions, respective direction form features of the pixels respectively corresponding to the line forms in the at least two directions; fuse, for each pixel of the pixels, the direction form features of the pixel respectively corresponding to the line forms in the at least two directions, to obtain a direction fusion feature of the pixel; and obtain the respective form features of the pixels based on the direction fusion features of the pixels.

In an embodiment, the form feature extraction module 1404 is further configured to: determine the at least one image feature form matching the feature form type in at least one image feature scale; and extract the respective form features of the pixels from the biological part image based on the at least one image feature form in the at least one image feature scale.

In an embodiment, the form feature extraction module 1404 is further configured to: extract, from the biological part image based on the at least one image feature form in at least two image feature scales, respective scale form features of the pixels respectively corresponding to the at least two image feature scales; fuse, for each pixel of the pixels, the scale form features of the pixel respectively corresponding to the at least two image feature scales, to obtain a scale fusion feature of the pixel; and obtain the respective form features of the pixels based on the scale fusion features of the pixels.

In an embodiment, the form feature extraction module 1404 is further configured to extract the respective form features of the pixels from the biological part image by using a convolutional network in a pre-trained feature extraction model, where the convolutional network is configured to perform feature extraction on the biological part image based on the at least one image feature form matching the feature form type; and the biological part feature obtaining module 1406 is further configured to extract the biological part feature of the to-be-recognized user from the respective form features of the pixels by using a part feature extraction network in the feature extraction model.

In an embodiment, the apparatus further includes a model training module, configured to: obtain a plurality of biological part image samples; extract sample form features of sample pixels from the biological part image samples by using a convolutional network in a to-be-trained feature extraction model; extract a biological part sample feature from the sample form features of the sample pixels by using a part feature extraction network in the to-be-trained feature extraction model; determine a training loss based on the biological part sample feature and the sample form features; and update the convolutional network and the part feature extraction network in the to-be-trained feature extraction model separately based on the training loss, and continue to train the convolutional network and the part feature extraction network until the training is completed, to obtain a trained feature extraction model.

In an embodiment, the model training module is further configured to: obtain a part feature extraction loss based on the biological part sample feature; determine a negative sample pair, where the negative sample pair includes biological part image samples carrying different identity labels; obtain a sample pair loss based on the sample form features of the biological part image samples in the negative sample pair; and obtain the training loss based on the part feature extraction loss and the sample pair loss.

In an embodiment, the biological part feature obtaining module 1406 is further configured to: splice the respective form features of the pixels based on the respective distribution positions of the pixels in the biological part image, to obtain a form feature of the biological part image; and perform feature extraction on the form feature of the biological part image, to obtain the biological part feature of the to-be-recognized user.

In an embodiment, the form feature extraction module 1404 is further configured to: determine a region of interest from the biological part image; determine the at least one image feature form matching the feature form type; and extract the respective form features of the pixels in the region of interest based on the at least one image feature form.

In an embodiment, the target part is a palm; and the form feature extraction module 1404 is further configured to: detect, from the biological part image, finger seam feature points between different fingers of the palm; determine a focus of interest and a region range parameter from the biological part image based on feature point positions of the finger seam feature points and feature point distances between the finger seam feature points; and determine the region of interest in the biological part image based on the focus of interest and the region range parameter.

In an embodiment, the feature matching module 1408 is further configured to: obtain registered part features of registered users; determine feature similarities between the biological part feature and the registered part features separately; and determine the identity recognition result of the to-be-recognized user based on the feature similarities.

All or some of modules in the identity recognition apparatus may be implemented by software, hardware, and a combination thereof. The foregoing modules may be built in or independent of a processor of a computer device in a hardware form, or may be stored in a memory of the computer device in a software form, so that the processor invokes and performs an operation corresponding to each of the foregoing modules.

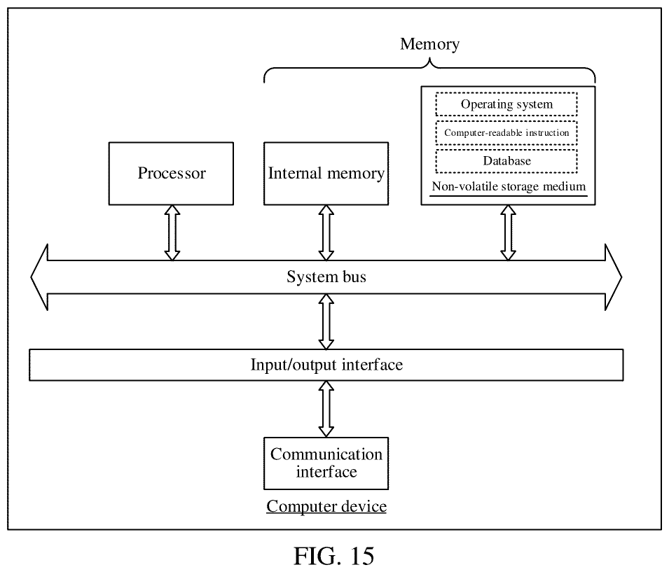

In an embodiment, a computer device is provided. The computer device may be a server or a terminal, and a diagram of an internal structure thereof may be shown in FIG. 15. The computer device includes a processor, a memory, an input/output interface (I/O for short), and a communication interface. The processor, the memory, and the input/output interface are connected by using a system bus, and the communication interface is connected to the system bus by using the input/output interface. The processor of the computer device is configured to provide computing and control capabilities. The memory of the computer device includes a non-volatile storage medium and an internal memory (e.g., non-transitory storage medium). The non-volatile storage medium stores an operating system, computer-readable instructions, and a database. The internal memory provides an environment for running of the operating system and the computer-readable instructions in the non-volatile storage medium. The database of the computer device is configured to store data related to identity recognition. The input/output interface of the computer device is configured to exchange information between the processor and an external device. The communication interface of the computer device is configured to communicate with an external terminal through a network connection. The computer-readable instructions are executed by the processor to implement an identity recognition method.

A person skilled in the art may understand that, the structure shown in FIG. 15 is merely a block diagram of a part of a structure related to the solution of this disclosure and does not constitute a limitation on the computer device to which the solution of this disclosure is applied. Specifically, the computer device may include more or fewer components than those shown in the figure, or some components may be combined, or a different component deployment may be used.

In an embodiment, a computer device is further provided, including a memory and a processor, where the memory stores computer-readable instructions, and the processor, when executing the computer-readable instructions, implements the operations in the foregoing method embodiments.

In some embodiment, a non-transitory computer-readable storage medium is provided, having computer-readable instructions stored therein, where when the computer-readable instructions are executed by a processor, the operations in the foregoing method embodiments are implemented.

In an embodiment, a computer program product is provided, including computer-readable instructions, where when the computer-readable instructions are executed by a processor, the operations in the foregoing method embodiments are implemented.

User information (including, but not limited to, user equipment information, user personal information, and the like) and data (including, but not limited to, data for analysis, stored data, displayed data, and the like) involved in this disclosure are all information and data authorized by a user or fully authorized by all parties, and collection, use, and processing of relevant data need to comply with relevant regulations.

A person of ordinary skill in the art may understand that all or some of the procedures of the methods of the foregoing embodiments may be implemented by computer-readable instructions instructing relevant hardware. The computer-readable instructions may be stored in a non-volatile computer-readable storage medium. When the computer-readable instructions are executed, the procedures of the embodiments of the foregoing methods may be included. Any reference to a memory, a database, or another medium used in the embodiments provided in this disclosure may include at least one of a non-volatile memory and a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, and the like. The volatile memory may include a random access memory (RAM) or an external cache. For the purpose of description instead of limitation, the random access memory (RAM) is available in a plurality of forms, such as a static random access memory (SRAM) or a dynamic random access memory (DRAM). The database involved in the embodiments provided in this disclosure may include at least one of a relational database and a non-relational database. The non-relational database may include a blockchain-based distributed database, but is not limited thereto. The processor involved in the embodiments provided in this disclosure may be a general-purpose processor, a central processing unit, a graphics processing unit, a digital signal processor, a programmable logic device, a quantum computing-based data processing logic device, but is not limited thereto.

The technical features of the foregoing embodiments may be randomly combined. For concise description, not all possible combinations of the technical features in the embodiment are described. However, the combinations of the technical features shall all be considered as falling within the scope recorded by this specification provided that no conflict exists.

The foregoing embodiments only describe several implementations of this disclosure, and are described in detail, but shall not be construed as a limitation to the patent scope of this disclosure. A person of ordinary skill in the art may make various changes and improvements without departing from the idea of this disclosure, and the changes and improvements shall all fall within the protection scope of this disclosure. Therefore, the protection scope of this disclosure is subject to the appended claims.

What is claimed is:

1. A method for identity recognition, performed by a computer device, the method comprising:
obtaining a biological part image for a target part of a to-be-recognized user;
determining a feature form type of the target part, and extracting form features of each pixel from the biological part image based on an image feature form matching the feature form type, wherein the image feature form is a form obtained after respective distribution positions of feature extraction coverage pixels are combined, and the feature extraction coverage pixels are pixels that are in the biological part image and targeted by each feature extraction;
obtaining a biological part feature of the to-be-recognized user based on the respective form features of the pixels; and
performing feature matching between the biological part feature and a registered part feature, to obtain feature matching results, and determining an identity recognition result of the to-be-recognized user based on the feature matching result, wherein the registered part feature is a biological part feature obtained by performing identity registration on a biological part image corresponding to a target part of a registered user corresponding to the target part of the to-be-recognized user.

2. The method according to claim 1, wherein
the target part is a palm, and the image feature form is a line form; and
extracting the form features of each pixel from the biological part image comprises:
extracting the form features of the each pixel from the biological part image based on a line form in at least one direction.

3. The method according to claim 1, wherein extracting the form features of the each pixel from the biological part image comprises:
extracting, according to line forms in at least two directions, direction pattern features for each pixel corresponding to the at least two directions;
fusing, for each pixel of the biological part image, direction form features of the pixel corresponding to the line forms in the at least two directions, to obtain a direction fusion feature of the pixel; and
obtaining the form features of the each pixel based on the direction fusion features of the each pixel.

4. The method according to claim 1, wherein extracting form features of the each pixel from the biological part image comprises:
determining at least one image feature form matching the feature form type in at least one image feature scale; and
extracting the form features of the each pixel from the biological part image based on the at least one image feature form in the at least one image feature scale.

5. The method according to claim 1, wherein extracting the form feature form of the each pixel from the biological part image comprises:
extracting, from the biological part image based on the at least one image feature form in at least two image feature scales, scale form features of the each pixel corresponding to the at least two image feature scales;
fusing, for the each pixel, the scale form features of the each pixel corresponding to the at least two image feature scales, to obtain a scale fusion feature of the pixel; and
obtaining the form features of the each pixel based on the scale fusion features of the each pixel.

6. The method according to claim 1, wherein:
extracting form features of the each pixel from the biological part image comprises:
extracting the form feature of the each pixel from the biological part image by using a convolutional network in a pre-trained feature extraction model,
wherein the convolutional network is configured to perform feature extraction on the biological part image based on the at least one image feature form matching the feature form type; and
obtaining the biological part feature of the to-be-recognized user based on the respective form features of the pixels comprises:
extracting the biological part feature of the to-be-recognized user from the respective form features of the pixels by using a part feature extraction network in the feature extraction model.

7. The method according to claim 1, wherein the feature extraction model is obtained by using operations of model training; and the operations of model training comprise:
obtaining a plurality of biological part image samples;
extracting respective sample form features of sample pixels from the biological part image samples by using a convolutional network in a to-be-trained feature extraction model;
extracting a biological part sample feature from the respective sample form features of the sample pixels by using a part feature extraction network in the to-be-trained feature extraction model;
determining a training loss based on the biological part sample feature and the sample form features; and
updating the convolutional network and the part feature extraction network in the to-be-trained feature extraction model separately based on the training loss, and continuing to train the convolutional network and the part feature extraction network until the training is completed, to obtain a trained feature extraction model.

8. The method according to claim 7, wherein determining the training loss comprises:
obtaining a part feature extraction loss based on the biological part sample feature;
determining a negative sample pair, wherein the negative sample pair comprises biological part image samples carrying different identity labels;
obtaining a sample pair loss based on the sample form features of the biological part image samples in the negative sample pair; and
obtaining the training loss based on the part feature extraction loss and the sample pair loss.

9. The method according to claim 8, wherein obtaining the biological part feature of the to-be-recognized user based on the respective form features of the pixels comprises:
splicing the respective form features of the pixels based on respective distribution position of the pixels in the biological part image, to obtain a form feature of the biological part image; and
performing feature extraction on the form feature of the biological part image, to obtain the biological part feature of the to-be-recognized user.

10. The method according to claim 1, wherein extracting form features of the each pixel from the biological part image comprises:
determining a region of interest from the biological part image;
determining the at least one image feature form matching the feature form type; and
extracting the respective form features of the each pixel in the region of interest based on the at least one image feature form.

11. The method according to claim 10, wherein the target part is a palm; and
determining the region of interest from the biological part image comprises:
detecting, from the biological part image, finger seam feature points between different fingers of the palm;
determining a focus of interest and a region range parameter from the biological part image based on feature point positions of the finger seam feature points and feature point distances between the finger seam feature points; and
determining the region of interest in the biological part image based on the focus of interest and the region range parameter.

12. The method according to claim 1, wherein performing feature matching on the biological part feature and registered part features, to obtain the feature matching results, and determining the identity recognition result of the to-be-recognized user based on the feature matching results comprises:
obtaining registered part features of registered users;
determining feature similarities between the biological part feature and the registered part features separately; and
determining the identity recognition result of the to-be-recognized user based on the feature similarities.

13. A device comprising a memory for storing computer instructions and a processor in communication with the memory, wherein, when the processor executes the computer instructions, the processor is configured to cause the device to:
obtain a biological part image for a target part of a to-be-recognized user;
determine a feature form type of the target part, and extract form features of each pixel from the biological part image based on an image feature form matching the feature form type, wherein the image feature form is a form obtained after respective distribution positions of feature extraction coverage pixels are combined, and the feature extraction coverage pixels are pixels that are in the biological part image and targeted by each feature extraction;
obtain a biological part feature of the to-be-recognized user based on the respective form features of the pixels; and
perform feature matching between the biological part feature and a registered part feature, to obtain feature matching results, and determine an identity recognition result of the to-be-recognized user based on the feature matching result, wherein the registered part feature is a biological part feature obtained by performing identity registration on a biological part image corresponding to a target part of a registered user corresponding to the target part of the to-be-recognized user.

14. The device according to claim 13, wherein
the target part is a palm, and the image feature form is a line form; and
when the processor is configured to cause the device to extract the form features of each pixel from the biological part image, the processor is configured to cause the device to:
extract the form features of the each pixel from the biological part image based on a line form in at least one direction.

15. The device according to claim 13, when the processor is configured to cause the device to extract the form features of the each pixel from the biological part image, the processor is configured to cause the device to:
extract, according to line forms in at least two directions, direction pattern features for each pixel corresponding to the at least two directions;
fuse, for each pixel of the biological part image, direction form features of the pixel corresponding to the line forms in the at least two directions, to obtain a direction fusion feature of the pixel; and
obtain the form features of the each pixel based on the direction fusion features of the each pixel.

16. The device according to claim 13, when the processor is configured to cause the device to extract the form features of the each pixel from the biological part image, the processor is configured to cause the device to:
determine at least one image feature form matching the feature form type in at least one image feature scale; and
extract the form features of the each pixel from the biological part image based on the at least one image feature form in the at least one image feature scale.

17. The device according to claim 13, when the processor is configured to cause the device to extract the form features of the each pixel from the biological part image, the processor is configured to cause the device to:
extract, from the biological part image based on the at least one image feature form in at least two image feature scales, scale form features of the each pixel corresponding to the at least two image feature scales;
fuse, for the each pixel, the scale form features of the each pixel corresponding to the at least two image feature scales, to obtain a scale fusion feature of the pixel; and
obtain the form features of the each pixel based on the scale fusion features of the each pixel.

18. The device according to claim 13, wherein:
when the processor is configured to cause the device to extract the form features of each pixel from the biological part image, the processor is configured to cause the device to:
extract the form feature of the each pixel from the biological part image by using a convolutional network in a pre-trained feature extraction model, wherein the convolutional network is configured to perform feature extraction on the biological part image based on the at least one image feature form matching the feature form type; and
when the processor is configured to cause the device to obtain the biological part feature of the to-be-recognized user based on the respective form features of the pixels, the processor is configured to cause the device to:
extract the biological part feature of the to-be-recognized user from the respective form features of the pixels by using a part feature extraction network in the feature extraction model.

19. The device according to claim 13, wherein the feature extraction model is obtained by using operations of model training; and the operations of model training comprise:
obtaining a plurality of biological part image samples;
extracting respective sample form features of sample pixels from the biological part image samples by using a convolutional network in a to-be-trained feature extraction model;
extracting a biological part sample feature from the respective sample form features of the sample pixels by using a part feature extraction network in the to-be-trained feature extraction model;
determining a training loss based on the biological part sample feature and the sample form features; and
updating the convolutional network and the part feature extraction network in the to-be-trained feature extraction model separately based on the training loss, and continuing to train the convolutional network and the part feature extraction network until the training is completed, to obtain a trained feature extraction model.

20. A non-transitory storage medium for storing computer readable instructions, the computer readable instructions, when executed by a processor, causing the processor to:
obtain a biological part image for a target part of a to-be-recognized user;
determine a feature form type of the target part, and extract form features of each pixel from the biological part image based on an image feature form matching the feature form type, wherein the image feature form is a form obtained after respective distribution positions of feature extraction coverage pixels are combined, and the feature extraction coverage pixels are pixels that are in the biological part image and targeted by each feature extraction;
obtain a biological part feature of the to-be-recognized user based on the respective form features of the pixels; and
perform feature matching between the biological part feature and a registered part feature, to obtain feature matching results, and determine an identity recognition result of the to-be-recognized user based on the feature matching result, wherein the registered part feature is a biological part feature obtained by performing identity registration on a biological part image corresponding to a target part of a registered user corresponding to the target part of the to-be-recognized user.
